(19) United States
(12) Patent Application Publication
(10) Pub. No.: US 2010/0328263 A1
(43) Pub. Date: Dec. 30, 2010

(54) RESISTIVE TOUCH PANEL AND METHOD FOR DETECTING TOUCH POINT TYPE

(75) Inventor: HUNG-YI LIN, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/822,585

(22) Filed: Jun. 24, 2010

(30) Foreign Application Priority Data
Jun. 29, 2009 (TW) 098121870

(51) Int. Cl. G06F 3/045

(52) U.S. Cl. 345/174; 178/18.05

(57) ABSTRACT

The invention discloses a method for detecting touch point type in a resistive touch panel. The method includes the steps of: connecting the first electrode to a voltage source and connecting the fourth electrode to the ground end when it is determined that a touch point is generated on the first detecting area, thereby making the second electrode generate a first voltage and the third electrode generate a second voltage; determining that the touch point is the first-type touch point when the difference between the first voltage and the second voltage is larger than a threshold value; and determining that the touch point is the second-type touch point when the difference between the first voltage and the second voltage is smaller than a first threshold value.

### FIELD OF THE INVENTION

The invention relates to a resistive touch panel and a detecting method thereof and, more particularly, to a resistive touch panel and the method for detecting a touch point type.

### BACKGROUND OF THE INVENTION

With the fast development of the computer technology, a touch panel is widely used in a mobile phone screen, a computer screen, a personal digital assistant (PDA) screen and so on. Basically, the touch panel may replace a mouse to be a computer input device. In the touch panels nowadays, a resistive touch panel is most popular.

As shown in FIG. 1A, it is a side view showing a conventional resistive touch panel. Multiple strip-shaped indium tin oxide (ITO) layers 102 are formed on the surface of a transparent glass substrate 100. In addition, multiple strip-shaped ITO layers 112 are formed on the surface of a transparent film 110. The strip-shaped ITO layers 102 on the transparent glass substrate 100 are perpendicular to the strip-shaped ITO layers 112 on the transparent film 110. In addition, multiple transparent spacer dots 120 isolate the strip-shaped ITO layers 102 on the transparent glass substrate 100 and the strip-shaped ITO layers 112 on the transparent film 110 to prevent them from contacting.

When the user presses the transparent film 110 with a finger or a stylus, the strip-shaped ITO layer 112 on the transparent file 110 is transformed and contacts the strip-shaped ITO layer 102 on the transparent glass substrate 100. The control circuit (not shown) of the touch panel calculates the position of the touch point.

As shown in FIG. 1B, it is a top view showing the conventional resistive touch panel. For example, four electrodes are disposed around the touch panel 10. They are a negative Y (Y−) electrode, a positive Y (Y+) electrode, a negative X (X−) electrode and a positive X (X+) electrode. In addition, the strip-shaped ITO layers 102 on the glass substrate are arranged vertically, and the two ends of all the strip-shaped ITO layers are connected to the negative Y (Y−) electrode and positive Y (Y+) electrode. The strip-shaped ITO layers 112 on the transparent film 110 are arranged horizontally, and the two ends of all the strip-shaped ITO layers 112 are connected to the negative X (X−) electrode and the positive X (X+) electrode. All the strip-shaped ITO layers 102 and 112 may be equivalent to resistors.

In addition, the control circuit 150 is respectively connected to the negative Y (Y−) electrode, the positive Y (Y+) electrode, the negative X (X−) electrode and the positive X (X+) electrode via the Y− line, the Y+ line, the X− line and the X+ line. When touch points are generated by the user on the touch panel 10, the control circuit 150 may obtain the position of the touch point quickly.

As shown in FIG. 2A, it is a schematic diagram showing that whether touch points are generated on the conventional resistive touch panel is detected. First, to know about whether the user touches the touch panel, the control circuit (not shown) connects a power source (Vcc) to the positive X (X+) electrode, connects the ground end to the negative Y (Y−) electrode, connects the negative X (X−) electrode to the control circuit to provide voltage Va and open the positive Y (Y+) electrode.

Obviously, when the user does not press the touch panel, the upper strip-shaped ITO layers and the lower strip-shaped ITO layers do not contact each other. Therefore, the control circuit may receive the voltage Va at the negative X (X−) electrode which is equal to the voltage Vcc. It represents that the user does not press the touch panel.

When the user presses the touch panel using a stylus 140, the upper strip-shaped ITO layers contact the lower strip-shaped ITO layers at the touch point A. Therefore, the control circuit detects that the negative X (X−) electrode receives a voltage

$$( Va = \frac{( R 4 + Rz ) \cdot Vcc}{R 1 + R z + R 4} )$$

which is smaller than the voltage Vcc. That is, it is determined that the user presses the touch panel. The contact resistance Rz is the contact resistance when the two strip-shaped ITO layers contact each other.

As shown in FIG. 2B, it is a schematic diagram showing the process of calculating the horizontal position of the touch point on the conventional resistive touch panel. The control circuit calculates the position of the touch point after it is determined that the user generates a touch point. To obtain the horizontal position of the touch point, when the control circuit detects the existence of the touch point A, it performs a switching process to connect a power source (Vcc) to the positive X (X+) electrode, connects the ground end to the negative X (X−) electrode, connects the positive Y (Y+) electrode to the control circuit to receive the voltage Vx and open the negative Y (Y−) electrode.

Obviously, the voltage on the positive Y (Y+) electrode is

$$Vx = \frac{R 2 \cdot Vcc}{R 1 + R 2} .$$

As shown in FIG. 2B, when the touch point A gets closer to the right side, the voltage Vx is higher, and on the contrary, when the touch point A gets closer to the left side, the voltage Vx is lower. Therefore, the control circuit may convert the voltage Vx via an analog to digital conversion to obtain the horizontal position of the touch point.

As shown in FIG. 2C, it is a schematic diagram showing the process of calculating the touch point on the conventional resistive touch panel. To obtain the vertical position of the touch point A, when the control circuit calculates the horizontal position of the touch point A, it performs the switching process again to connect a power source (Vcc) to the positive Y (Y+) electrode, connect the ground end to the negative Y (Y−) electrode, connect the positive X (X+) electrode to the control circuit to receive the voltage Vy and open the negative X (X−) electrode.

Obviously, the voltage at the positive X (X+) electrode is

$$Vy = \frac{R 4 \cdot Vcc}{R 3 + R 4} .$$

As shown in FIG. 2C, when the touch point A gets closer to the upper side, the voltage Vy is higher, and on the contrary, when the touch point A gets closer to the lower side, the voltage Vy is lower. Therefore, the control circuit may convert the voltage Vy via an analog to digital conversion to obtain the vertical position of the touch point.

Obviously, the touch panel is a detecting area surrounded by four electrodes (the negative Y electrode, the positive Y electrode, the negative X electrode and the positive X electrode). In addition, FIG. 2A shows the detection of whether the detecting area has touch points. When the touch point is generated, the control circuit performs the steps in FIG. 2B and FIG. 2C to obtain the horizontal position and vertical position of the touch point. On the contrary, when the touch point is not generated, the control circuit continues waiting for the generation of the touch point.

Since the conventional resistive touch panel is an analog touch panel, when multiple touch points are generated by a user in the touch panel simultaneously, the control circuit is unable to detect multiple touch points, and it may calculate a wrong touch point. For example, as shown in FIG. 3, it is a schematic diagram showing that multiple touch points are generated on the conventional resistive touch panel. The detecting area 160 is defined by four electrodes (not shown). When two touch points A1 and A2 are generated simultaneously in the detecting area 160, supposing that the horizontal position and vertical position of the touch point A1 is (x1, y1), and the horizontal position and vertical position of the touch point A2 is (x2, y2), the control circuit may wrongly detect a third touch point A3. The horizontal position and vertical position of A3 may be detected to be (x1+x2)/2 and (y1+y2)/2.

To detect multiple touch points on the resistive touch panel, the new type of resistive touch panel is developed. As shown in FIG. 4A, it is a schematic diagram showing the resistive touch panel which may detect multiple touch points. In FIG. 4A, the resistive touch panel includes four groups of electrodes (X1+ to X3+, X1 to X3−, Y1+ to Y4+, Y12− to Y4−). In addition, in the resistive touch panel, the X+ group and X− group have three electrodes, respectively, and the Y+ group and Y− group have four electrodes, respectively. The amount of electrodes in each group is not limited herein, and it may be changed.

In FIG. 4A, three electrodes in a positive X (X+) group are a positive X1 (X1+) electrode, a positive X2 (X2+) electrode and a positive X3 (X3+) electrode; three electrodes in a negative X (X−) group are a negative X1 (X1−) electrode, a negative X2 (X2−) electrode and a negative X3 (X3−) electrode; three electrodes in a positive Y (Y+) group are a positive Y1 (Y1+) electrode, a positive Y2 (Y2+) electrode, a positive Y3 (Y3+) electrode and a positive Y4 (Y4+) electrode; and three electrodes in a negative Y (Y−) group are a negative Y1 (Y1−) electrode, a negative Y2 (Y2−) electrode, a negative Y3 (Y3−) electrode and a negative Y4 (Y4−) electrode. Obviously, four groups of electrodes divide the resistive touch panel into twelve areas. For example, the X1+ electrode, the X1− electrode, the Y1+ electrode and the Y1− electrode form the detecting area D₁₁, and others are by parity of reasoning.

In addition, the multiplex switching circuit 230 are connected to all electrodes, and it may selectively connect an X+ line to part or all electrodes in the X+ group, connect an X− line to part or all electrodes in the X− group, connect a Y+ line to part or all electrodes in the Y+ group and connect a Y− line to part or all electrodes in the Y− group according to a control signal of the control circuit 250.

The touch panel which may detect multiple touch points in the embodiment of the invention is illustrated hereinbelow in detail. As shown in FIG. 4B, it is a schematic diagram showing an equivalent circuit during the touch point detecting procedure. To detect whether a touch point is generated on the touch panel 200, the control circuit 250 connects the X+line to all electrodes in the X+ group, connects the X− line to all electrodes in the X− group, connects the Y+ line to all electrodes in the Y+ group and connects the Y− line to all electrodes in the Y− group. In addition, the control circuit 250 performs the first switching action to connect a power source (Vcc) to the X+ line, connect the ground end to the Y− line, take a signal of the X− line as a determining signal and open the Y+ line. The control circuit 250 may detect whether a touch point is generated in all areas of the touch panel 200, and the detecting way is the same as that in FIG. 2A, and it is not illustrated herein.

For example, when the control circuit 250 knows that the user generates a touch point (such as the touch point B1), the control signal of the control circuit 250 controls the multiplex switching circuit 230 to orderly connect the X− line, the X+ line the Y− line and the Y+ line to the twelve detecting areas and detects whether the touch point is generated in the twelve detecting areas. At last, as shown in FIG. 4C, the touch point B1 is obtained at the area D31 defined by the Y1+, Y1−, X3+ and X3− electrodes, and the horizontal position and vertical position of the touch point B1 is obtained. In addition, the way of calculating the position of the touch point B1 is the same as those in FIG. 2B and FIG. 2C, and it is not illustrated again.

Similarly, as shown in FIG. 5, when multiple touch points (such as B1, B2 and B3) are generated at a time by the user, the control circuit 250 knows that the user generates the touch point. However, the control circuit 250 cannot know whether the user generates a single touch point or multiple touch points at the moment.

Then, the control signal of the control circuit 250 controls the multiplex switching circuit 230 to connect the X− line, the X+ line, the Y− line, and the Y+ line to the twelve detecting areas and detects whether the touch point is generated in the twelve detecting areas. At last, it is known that the detecting area D₁₃, the detecting area D₃₁, the detecting area D₃₃ have a touch point, respectively, and the control circuit may calculate the position of the touch point B2 in the detecting area D₁₃, the position of the touch point B1 in the detecting area D₃₁ and the position of the touch point B3 in the detecting area D₃₄.

Sometimes, the user may carelessly generate a plurality of touch points, and the control circuit of the conventional touch panel which may detect multiple touch points also calculates the positions of the touch points. As shown in FIG. 6, when the user operates the touch panel with the stylus 140, he or she always puts the finger 130 or the palm 135 on the touch panel 200. At that moment, the control circuit calculates multiple touch points. However, the touch point generated by the finger or the palm is not the effective touch point.

### SUMMARY OF THE INVENTION

The invention discloses a method for detecting a touch point type in a resistive touch panel. The resistive touch panel includes multiple detecting areas, and a first detecting area in the detecting areas is defined by a first electrode, a second electrode, a third electrode and a fourth electrode. The first electrode and the second electrode belong to first-direction electrodes, and the third electrode and the fourth electrode belong to second-direction electrodes. The method includes the steps of: connecting the first electrode to a voltage source and connecting the fourth electrode to a ground end when it is determined that a touch point is generated on the first detecting area, thereby making the second electrode generate a first voltage and the third electrode generate a second voltage; determining that the touch point a first-type touch point when the difference between the first voltage and the second voltage is larger than a first threshold value; and determining that the touch point is the second-type touch point when the difference between the first voltage and the second voltage is smaller than the first threshold value.

The invention also discloses a method for detecting a touch point type in a resistive touch panel. The resistive touch panel includes multiple detecting areas, and a first detecting area in the detecting areas is defined by a first electrode, a second electrode, a third electrode and a fourth electrode. The first electrode and the second electrode belong to first-direction electrodes and the third electrode and the fourth electrode belong to second-direction electrodes. The method includes the steps of: connecting the first electrode to a voltage source and connecting the second electrode to the ground end when it is determined that a touch point is generated on the first detecting area, thereby making the third electrode generate a third voltage and the fourth electrode generate a fourth voltage; determining that the touch point is the first-type touch point when the difference between the third voltage and the fourth voltage is smaller than a threshold value; and determining that the touch point is the second-type touch point when the difference between the third voltage and the fourth voltage is larger than a first threshold value.

The invention also discloses a method for detecting a touch point type in a resistive touch panel. The resistive touch panel includes multiple detecting areas, and a first detecting area in the detecting areas is defined by a first electrode, a second electrode, a third electrode and a fourth electrode. The first electrode and the second electrode belong to first-direction electrodes and the third electrode and the fourth electrode belong to second-direction electrodes. The method includes the steps of: connecting the third electrode to a voltage source and connecting the fourth electrode to the ground end when it is determined that a touch point is generated on the first detecting area, thereby obtaining a contact voltage of the touch point; switching the voltage source to the first electrode from the third electrode and connecting the fourth electrode to the ground end to make the second electrode generate a first voltage and the third electrode generate a second voltage; calculating the contact resistance according to the contact voltage, the current value, the first voltage and the second voltage; determining that the touch point is the first-type touch point when the contact resistance is larger than a preset contact resistance; and determining that the touch point is the second-type touch point when the contact resistance is smaller than the preset contact resistance.

The invention further discloses a resistive touch panel which includes: a first-direction first electrode group including m electrodes; a first-direction second electrode group including m electrodes; a second-direction first electrode group including n electrodes; and a second-direction second electrode group including n electrodes, a multiplex switching circuit and a control circuit. The 2 m+2n electrodes may divide the resistive touch panel into m×n detecting areas. The multiplex switching circuit is connected to all the 2 m+2n electrodes. When it is determined that a touch point is generated at a first detecting area in the detecting areas, whether the touch point is a first-type touch point or a second-type touch point is determined.

These and other features, aspects and advantages of the present invention will become better understood with regard to the following description, appended claims, and accompanying drawings.

### BRIEF DESCRIPTION OF THE DRAWINGS

FIG. 1A is a side view diagram showing a conventional resistive touch panel;

FIG. 1B is a top view diagram showing the conventional resistive touch panel;

FIG. 2A is a schematic diagram showing that whether touch points are generated on the conventional resistive touch panel is detected;

FIG. 2B is a schematic diagram showing the process of calculating the horizontal position of the touch point on the conventional resistive touch panel;

FIG. 2C is a schematic diagram showing the process of calculating the touch point on the conventional resistive touch panel;

FIG. 3 is a schematic diagram showing that multiple touch points are generated on the conventional resistive touch panel;

FIG. 4A is a schematic diagram showing the resistive touch panel which may detect multiple touch points;

FIGS. 4B and 4C are schematic diagrams showing an equivalent circuit during the touch point detecting procedure;

FIG. 5 is a schematic diagram showing that multiple touch points are detected on the resistive touch panel;

FIG. 6 is a schematic diagram showing that the user operates the touch panel;

FIG. 7A is a schematic diagram showing that the touch point is generated by a finger;

FIG. 7B, it is a schematic diagram showing that the touch point is generated by a stylus;

FIG. 8 is a schematic diagram showing the resistive touch panel which may detect multiple touch points.

FIG. 9A is a schematic diagram showing a detecting area in the touch panel; and

FIG. 9B is a schematic diagram showing a detecting area in the touch panel.

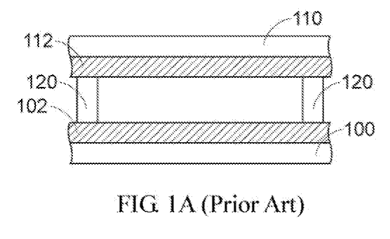

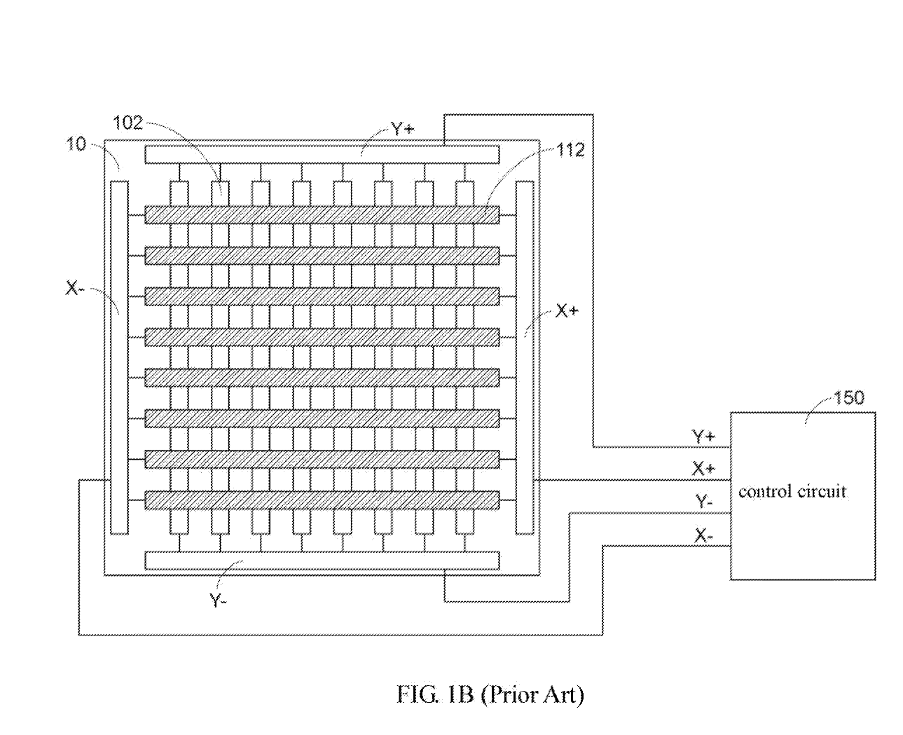

### DETAILED DESCRIPTION OF THE PREFERRED EMBODIMENT

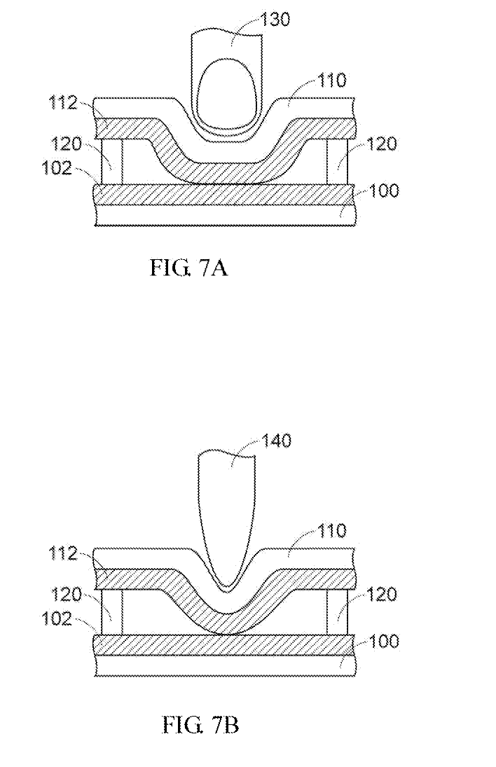

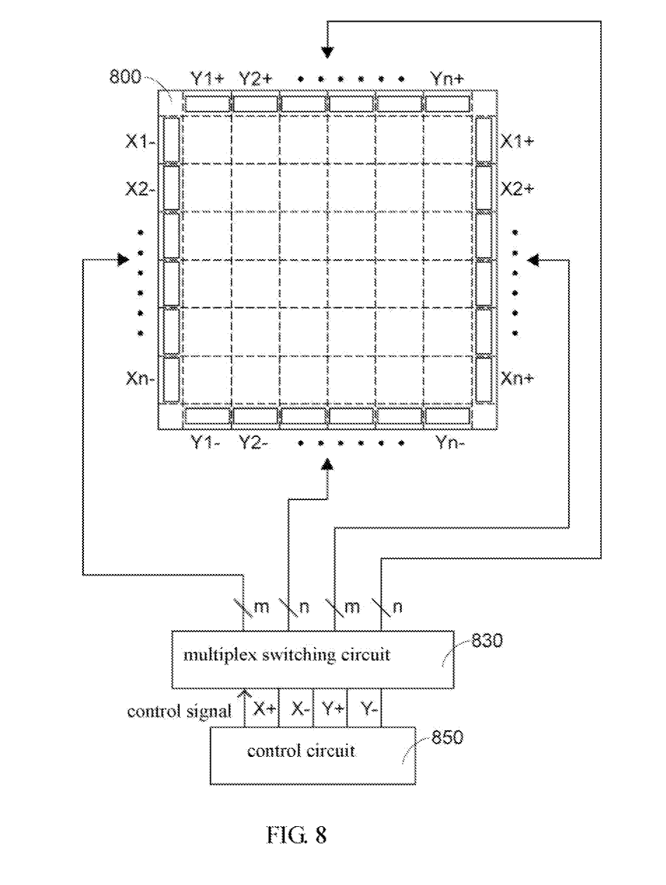

FIG. 7A is a schematic diagram showing that the touch point is generated by a finger. When a finger 130 is used to press the touch panel, the contact area between the upper and lower stripe-shaped ITO layers 112 and 102 is larger due to the large contact area. Similarly, when the touch point is generated by a palm, the contact area between the upper and lower stripe-shaped ITO layers 112 and 122 is also larger. In addition, as shown in FIG. 7B, it is a schematic diagram showing that the touch point is generated by a stylus 140. Since the area of the penpoint of the stylus is small, when the stylus is used to press the touch panel, the contact area between the upper and lower ITO layers is small. In the invention, the contact area is used to determine whether the touch point is the first-type touch point or the second type touch point. The first-type touch point is the small-area touch point, such as the stylus touch point, the sharp object touch point, and the palm touch point, and the second-type touch point is a large-area touch point such as a finger touch point and a palm touch point.

FIG. 8 is a schematic diagram showing the resistive touch panel which may detect multiple touch points. The resistive touch panel in FIG. 8 includes four electrode groups, which are an X-direction first electrode group (X1+ to Xm+), an X-direction second electrode group (X1− to Xm−), a Y-direction first electrode group (Y1+ to Yn+) and a Y-direction second electrode group (Y1− to Yn−). The resistive touch panel 800 herein is divided into m×n detecting areas.

The multiplex switching circuit 830 is connected to all electrodes, and it may selectively connect an X+ line to part or all electrodes in the X+ group, connect an X− line to part or all electrodes in the X− group, connect a Y+ line to part or all electrodes in the Y+ group, and connect a Y− line to part or all electrodes in the Y− group.

At first, the step (I) determining the generation of the touch point is performed. That is, to know whether the user generates the touch point on the touch panel 800, the control circuit 850 connects the X+ line to all electrodes in the X+ group, connects the X− line to all electrodes in the X− group, connects the Y+ line to all electrodes in the Y+ group, and connects the Y− line to all electrodes in the Y− group. In addition, the control circuit 850 performs the first switching action to connect a power source (Vcc) to the X+ line, connect the ground end to the Y− line, take a signal of the X− line as a determining signal and open the Y+ line. At that moment, the control circuit 850 may detect whether a touch point is generated in all area of the touch panel 800 according to the change of the determining signal.

When the control circuit 850 knows that the touch point is generated by the user, the step (II) searching for the touch point is performed. During searching for the touch point, the control signal of the control circuit 850 may control the multiplex switching circuit 830 to connect the m×n detecting areas and detect whether the touch point is generated on m×n detecting areas.

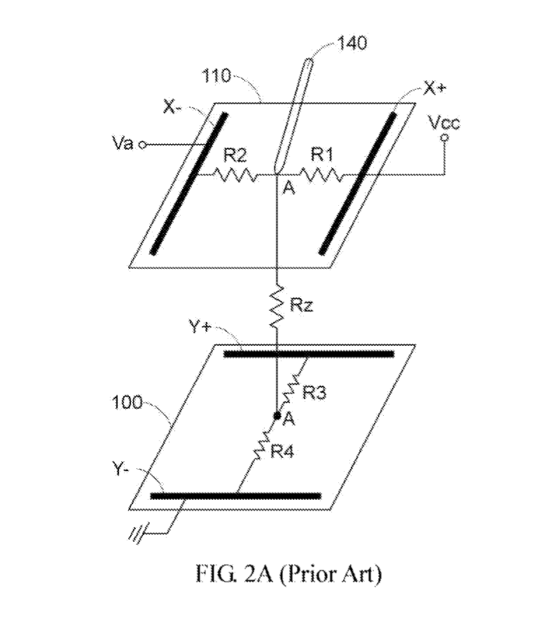

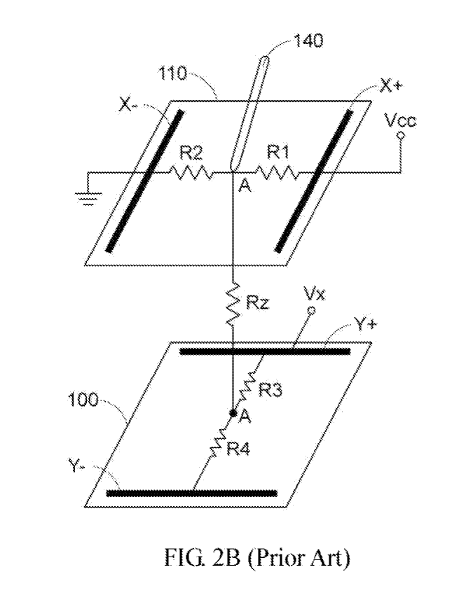

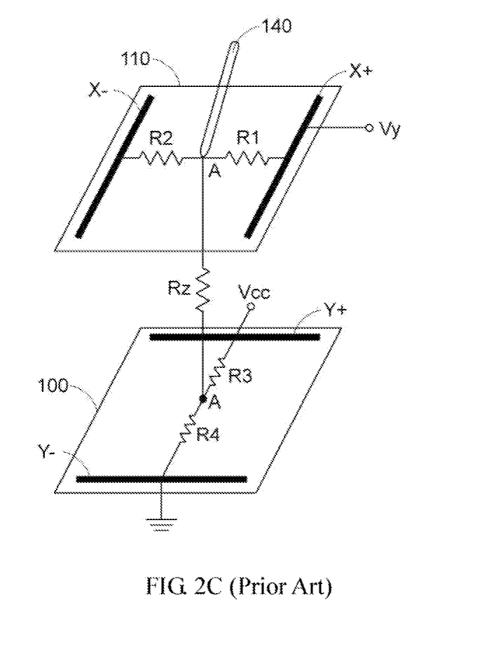

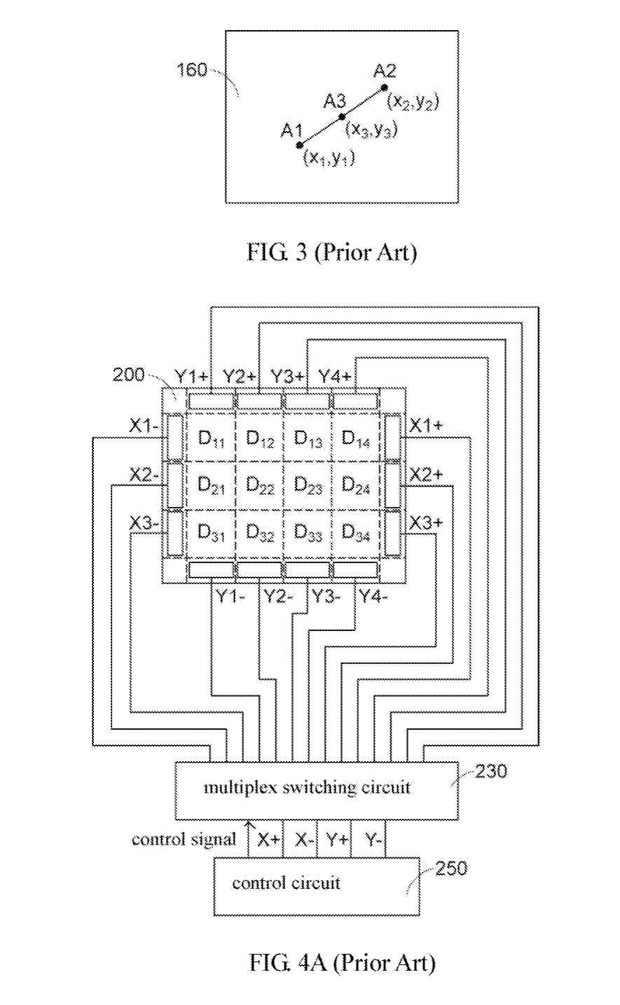

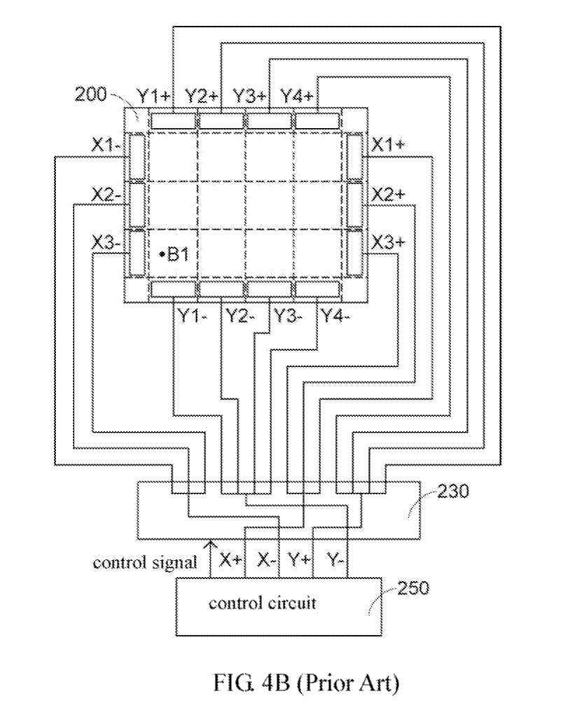

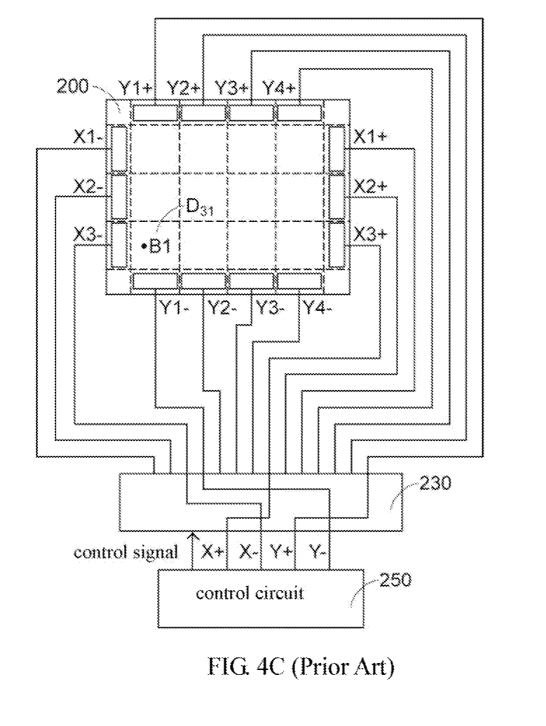

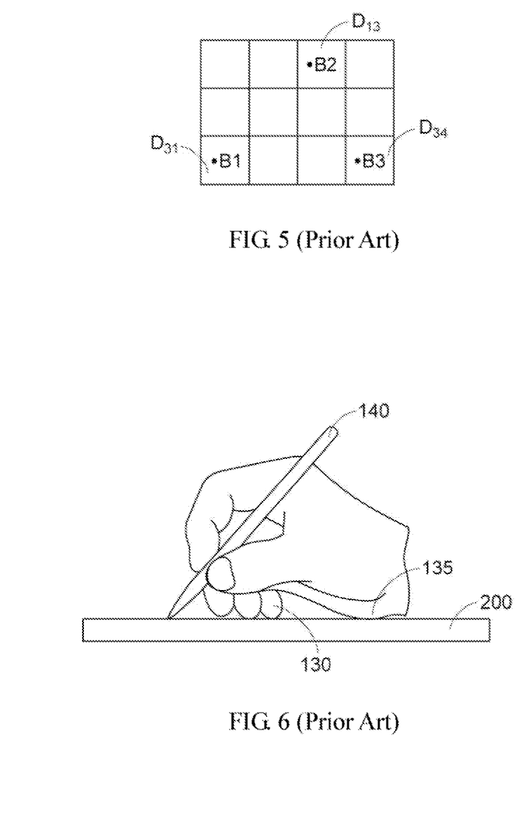

When one or more detecting areas are determined to have touch points, the control circuit 850 may calculate the horizontal position and vertical position of the touch point on the detecting area. In addition, the method for calculating the position of the touch point is the same as those in FIG. 2B and FIG. 3, and it is not illustrated herein for a concise purpose.

According to an embodiment of the invention, the control circuit 850 must perform the step (III) to determine the touch point type. Since the contact area of the touch point is large (for example, the touch point is generated by finger or palm), and the contact area between the upper and lower ITO layers is large, the contact resistance (Rz) is small. On the contrary, when the contact area of the touch point is small (for example, the touch point is generated by stylus), the contact area of the upper and lower ITO layers is small, and the contact resistance (Rz) is large.

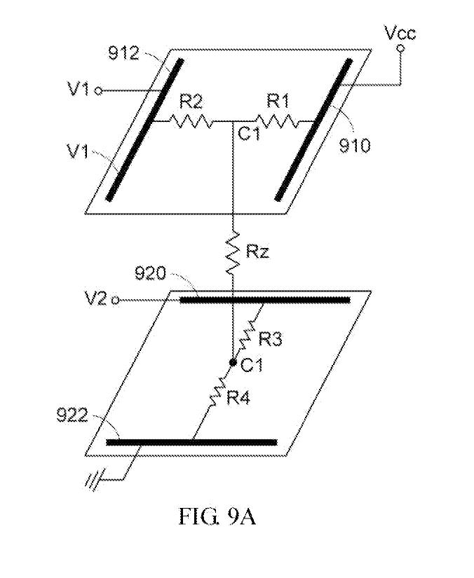

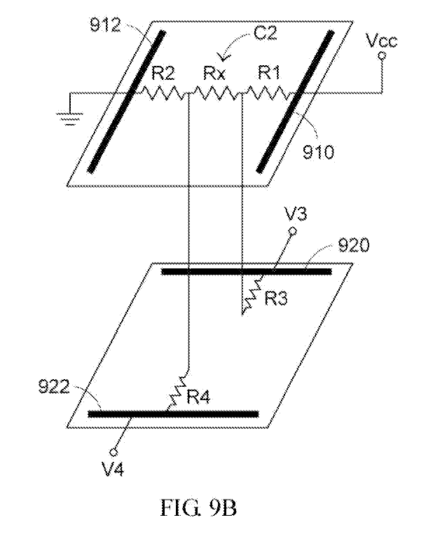

FIG. 9A is a schematic diagram showing the detecting area in the touch panel. The detecting area is defined by the first electrode 910, the second electrode 912, the third electrode 920 and the fourth electrode 922. The first electrode 910 and the second electrode 912 belong to the first-direction electrodes (such as the X+ electrode and X− electrode). The third electrode 920 and the fourth electrode 922 belong to the second-direction electrodes (such as the Y+ electrode and Y− electrode.) In addition, it is determined that the detecting area 900 has a touch point C1. According to the first embodiment of the invention, to determine the type of the touch point C1, the control circuit connects a voltage source (Vcc) to the first electrode, connects the ground end to the fourth electrode, connects the second electrode to the control circuit to provide a first voltage (V1), and connects the third electrode to the control circuit to provide a second voltage (V2).

The type of the touch point C1 is determined by the first voltage (V1) and the second voltage (V2). As shown in FIG. 9A, the larger the contact area of the touch panel is, the smaller the contact resistance (Rz) is, and therefore the first voltage (V1) is close to the second voltage (V2). That is |V1−V2|<Vth1. On the contrary, the smaller the contact area of the touch point is, the larger the contact resistance (Rz) is, and therefore the difference between the first voltage (V1) and the second voltage (V2) is larger. That is |V1−V2|>Vth1. The Vth1 herein is the preset first threshold value.

As depicted in the first embodiment, when |V1−V2|>Vth1, the touch point C1 is determined to be the first-type touch point such as the stylus touch point, the sharp object touch point, the palm touch point with small contact area. On the contrary, when |V1−V2|<Vth1, the touch point C1 is determined to be the second-type touch point such as the finger touch point and the palm touch point with larger contact area.

Furthermore, in the invention, after the first voltage (V1) and the second voltage (V2) are obtained, the value of the contact resistance (Rz) also may be directly calculated, and the touch point type is determined according to the contact resistance (Rz). For example, when the position of the second direction is calculated, the third electrode 920 is connected to the voltage source (Vcc), and the fourth electrode 922 is connected to the ground end. Therefore, the voltage on the touch point C1 is

$$Vc 1 = \frac{R 4}{R 3 + R 4} Vcc ,$$

and the position of the first direction is obtained via the value Vc1. In addition, as shown in FIG. 9A,

$$V 1 = \frac{R 4 + R z}{R 4 + Rz + R 1} Vcc , and V 2 = \frac{R 4}{R 4 + Rz + R 1} Vcc .$$

That is, the control circuit may obtain the voltage value of Vc1, the V1 and the V2. As shown in the formula hereinbelow:

$$Vc 1 ( \frac{V 1}{V 2} - 1 ) = ( \frac{R 4}{R 3 + R 4} Vcc ) ( \frac{R 4 + Rz}{R 4} - 1 ) = ( \frac{R 4}{R 3 + R 4} Vcc ) ( \frac{Rz}{R 4} ) = Rz ( \frac{Vcc}{R 3 + R 4} )$$

$$Vc 1 ( \frac{V 1}{V 2} - 1 )$$

is a constant value, and

$$( \frac{Vcc}{R 3 + R 4} )$$

is the value of the current passing through the voltage source and the ground end when the position of the second direction is calculated. Therefore, the contact resistance (Rz) is deduced.

Therefore, in the invention, after the contact resistance (Rz) is calculated, the contact resistance is compared with a preset contact resistance (Rz0). When the calculated contact resistance (Rz) is larger than the preset contact resistance (Rz0), the touch point C1 is the first-type touch point; on the contrary, when the calculated contact resistance (Rz) is smaller than the preset contact resistance (Rz0), the touch point C1 is the second-type touch point.

FIG. 9B is a schematic diagram showing the detecting area in the touch panel. The detecting area is defined by the first electrode 910, the second electrode 912, the third electrode 920 and the fourth electrode 922. The first electrode 910 and the second electrode 912 belong to the first-direction electrodes (such as the X+ electrode and X− electrode), and the third electrode 920 and the fourth electrode 922 belong to the second-direction electrodes (such as the Y+ electrode and Y− electrode). In addition, it is determined that the detecting area has a touch point C2, and according to the embodiment of the invention, to determine the type of the touch point C2, the control circuit connects a voltage source (Vcc) to the first electrode, connects the ground end to the second electrode, connects the third electrode to the control circuit to provide a third voltage (V3), and connects the fourth electrode to the control circuit to provide a fourth voltage (V4).

The type of the touch point C2 is determined by the third voltage (V3) and the fourth voltage (V4). As shown in FIG. 9B, R1, Rx and R2 form a liner ITO layer. As a result, the larger the contact area of the touch point is, the longer the liner ITO layer occupied by the resistor R2 is, and the larger the value of R2 is. Therefore, the difference between the third voltage (V3) and the fourth voltage (V4) is larger, and that is |V3−V4|>Vth2. On the contrary, when the contact area of the touch point is small, the resistor R2 is small. Therefore, the third voltage (V3) and the fourth voltage (V4) is closer to each other, and that is |V3−V4|<Vth2. The Vth2 is the preset second threshold value.

As illustrated in the second embodiment, when |V3−V4|<Vth2, the touch point C2 is determined to be the first-type touch point such as the stylus touch point, the sharp object touch point, and the palm touch point with small contact area. On the contrary, when |V3−V4|>Vth2, the touch point C2 is determined to be the second-type touch point such as the finger touch point and the palm touch point with larger contact area.

In the embodiment, the invention provides a resistive touch panel and the method for detecting the touch point type. When touch points are generated in one or more detecting areas, the touch point and the touch point type are determined quickly. When the resistive touch panel has different touch point types, the touch points may be divided into effective touch point and ineffective touch point.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A method for detecting a touch point type of a resistive touch panel, wherein the resistive touch panel includes multiple detecting areas, and a first detecting area in the detecting areas is defined by a first electrode, a second electrode, a third electrode and a fourth electrode, the first electrode and the second electrode belong to first-direction electrode, and the third electrode and the fourth electrode belong to second-direction electrodes, the method for detecting the touch point type comprising the steps of:
connecting the first electrode to a voltage source and connecting the fourth electrode to a ground end when a touch point is generated on the first detecting area, thereby making the second electrode generate a first voltage and the third electrode generate a second voltage; and
determining that the touch point is a first-type touch point when the difference between the first voltage and the second voltage is larger than a first threshold value, and determining that the touch point is a second-type touch point when the difference between the first voltage and the second voltage is smaller than the first threshold value.

2. The method for detecting the touch point type according to claim 1, wherein the first-type touch point is a small-area touch point, and the second-type touch point is a large-area touch point.

3. The method for detecting the touch point type according to claim 1, wherein the first-type touch point is a stylus touch point, a penpoint touch point or a sharp object touch point, and the second-type touch point is a finger touch point or a palm touch point.

4. The method for detecting the touch point type according to claim 1, wherein the first-direction electrodes are along an X-direction, the first electrode and the second electrode correspond to each other, the second-direction electrodes are along a Y-direction, and the third electrode and the fourth electrode correspond to each other.

5. A method for detecting a touch point type of a resistive touch panel, wherein the resistive touch panel includes multiple detecting areas, and a first detecting area in the detecting areas is defined by a first electrode, a second electrode, a third electrode and a fourth electrode, the first electrode and the second electrode belong to first-direction electrodes, and the third electrode and the fourth electrode belong to second-direction electrodes, the method for detecting the touch point type comprising the steps of:
connecting the third electrode to a voltage source and connecting the fourth electrode to a ground end when a touch point is generated on the first detecting area, thereby obtaining a contact voltage of the touch point and a current value passing through the touch point;
switching the voltage source to the first electrode from the third electrode and connecting the fourth electrode to the ground end to make the second electrode generate a first voltage and the third electrode generate a second voltage;
calculating a contact resistance according to the contact voltage, the current value, the first voltage and the second voltage; and
determining that the touch point is a first-type touch point when the contact resistance is larger than a preset contact resistance, and determining that the touch point is a second-type touch point when the contact resistance is smaller than the preset contact resistance.

6. The method for detecting the touch point type according to claim 5, wherein the first-type touch point is a small-area touch point, and the second-type touch point is a large-area touch point.

7. The method for detecting the touch point type according to claim 5, wherein the first-type touch point is a stylus touch point, a penpoint touch point or a sharp object touch point, and the second-type touch point is a finger touch point or a palm touch point.

8. The method for detecting the touch point type according to claim 5, wherein the first-direction electrodes are along an X-direction, the first electrode and the second electrode correspond to each other, the second-direction electrodes are along a Y-direction, and the third electrode and the fourth electrode correspond to each other.

9. A method for detecting a touch point type of a resistive touch panel, wherein the resistive touch panel includes multiple detecting areas, and a first detecting area in the detecting areas is defined by a first electrode, a second electrode, a third electrode and a fourth electrode, the first electrode corresponds to the second electrode, the third electrode corresponds to the fourth electrode, the method for detecting the touch point type comprising the steps of:
connecting the first electrode to a voltage source and connecting the second electrode to a ground end when a touch point is generated on the first detecting area, thereby making the third electrode generate a third voltage and the fourth electrode generate a fourth voltage; and
determining that the touch point is a first-type touch point when the difference between the third voltage and the fourth voltage is smaller than a threshold value, and determining that the touch point is a second-type touch point when the difference between the third voltage and the fourth voltage is larger than the threshold value.

10. The method for detecting the touch point type according to claim 9, wherein the first-type touch point is a small-area touch point, and the second-type touch point is a large-area touch point.

11. The method for detecting the touch point type according to claim 9, wherein the first-type touch point is a stylus touch point, a penpoint touch point or a sharp object touch point, and the second-type touch point is a finger touch point or a palm touch point.

12. The method for detecting the touch point type according to claim 9, wherein the first-direction electrodes are along an X-direction, the first electrode and the second electrode correspond to each other, the second-direction electrodes are along a Y-direction, and the third electrode and the fourth electrode correspond to each other.

13. A resistive touch panel comprising:
a first-direction first electrode group including m electrodes;
a first-direction second electrode group including m electrodes;
a second-direction first electrode group including n electrodes;
a second-direction second electrode group including n electrodes;
wherein the 2m+2n electrodes divide the resistive touch panel into m×n detecting areas;
a multiplex switching circuit connected to each of the 2m+2n electrodes; and
a control circuit, determining that a touch point is a first-type touch point or a second-type touch point when the touch point is generated at a first detecting area in the detecting areas.

14. The resistive touch panel according to claim 13, wherein the first detecting area is defined by a first electrode, a second electrode, a third electrode and a fourth electrode, the first electrode belongs to the first-direction first electrode group, the second electrode belongs to the first-direction second electrode group, the third electrode belongs to the second-direction first electrode group, and the fourth electrode belongs to the second-direction second electrode group.

15. The resistive touch panel according to claim 13, wherein when a touch point is generated on the first detecting area, the first electrode is connected to a voltage source and the fourth electrode is connected to the ground end to make the second electrode generate a first voltage and the third electrode generate a second voltage; when the difference between the first voltage and the second voltage is larger than a threshold value, it is determined that the touch point is the first-type touch point; and when the difference between the first voltage and the second voltage is smaller than the threshold value, it is determined that the touch point is the second-type touch point.

16. The resistive touch panel according to claim 13, wherein when it is determined that a touch point is generated on the first detecting area, the first electrode is connected to a voltage source and the second electrode is connected to the ground end to make the third electrode generate a third voltage and the fourth electrode generate a fourth voltage; and when the difference between the third voltage and the fourth voltage is smaller than a threshold value, it is determined that the touch point is the first-type touch point; and when the difference between the third voltage and the fourth voltage is larger than the threshold value, it is determined that the touch point is the second-type touch point.

17. The resistive touch panel according to claim 13, wherein the first-type touch point is a small-area touch point, and the second-type touch point is a large-area touch point.

18. The resistive touch panel according to claim 13, wherein the first-type touch point is a stylus touch point, a penpoint touch point or a sharp object touch point, and the second-type touch point is a finger touch point or a palm touch point.
